(19) United States
(12) Patent Application Publication
(10) Pub. No.: US 2026/0275889 A1
(43) Pub. Date: Sep. 17, 2026

(54) VENTILATION SYSTEM

(71) Applicant: TOYOTA JIDOSHA KABUSHIKI KAISHA, Toyota-shi (JP)

(72) Inventors: Ryota IWASAKI, Okazaki-shi (JP); Hibiki UEURA, Toyota-shi (JP); Shuya IKESUE, Toyota-shi (JP)

(73) Assignee: TOYOTA JIDOSHA KABUSHIKI KAISHA, Toyota-shi (JP)

(21) Appl. No.: 19/557,685

(22) Filed: Mar. 5, 2026

(30) Foreign Application Priority Data
Mar. 11, 2025 (JP) 2025-038129

(51) Int. Cl. F01M 13/00; F01M 13/02

(52) U.S. Cl. CPC F01M 13/0011; F01M 13/021; F01M 2013/027

(57) ABSTRACT

A first PCV valve opens when a pressure of an intake passage at a downstream side of a compressor becomes lower than or equal to a first specified pressure, which is lower than the atmospheric pressure. When a logical conjunction including a condition that discharging of a battery is permitted and a condition that the pressure of the intake passage at the downstream side of the compressor is higher than or equal to a first threshold value and lower than or equal to a second threshold value remains satisfied for a predetermined period, a vehicle controller executes a ventilation process. The ventilation process includes driving a hydrogen engine so that the pressure of the intake passage at the downstream side of the compressor becomes lower than or equal to the first specified pressure. The ventilation process includes assisting in output of the hydrogen engine with a motor-generator.

### CROSS-REFERENCE TO RELATED APPLICATIONS

This application is based upon and claims the benefit of priority from Japanese Patent Application No. 2025-038129, filed on Mar. 11, 2026, the entire contents of which are incorporated herein by reference.

### BACKGROUND

### 1. Field

The following description relates to a ventilation system.

### 2. Description of Related Art

JP2024-076657A discloses a vehicle including an internal combustion engine. The internal combustion engine includes a positive crankcase ventilation (PCV) valve. The PCV valve is arranged in a blow-by gas passage. The blow-by gas passage is a passage extending from a crankcase to a surge tank. The PCV valve adjusts an amount of blow-by gas that flows through the blow-by gas passage. When blow-by gas leaks from a combustion chamber of the internal combustion engine into the crankcase, the blow-by gas passage delivers the blow-by gas to an intake system of the internal combustion engine.

In a state in which the internal combustion engine is idling, since the surge tank is located downstream of a throttle valve, descending of a piston causes the pressure of the surge tank to become negative. When the pressure of the surge tank is negative, the PCV valve is open such that the blow-by gas flows from the crankcase to the intake system. In this manner, the crankcase is ventilated through the PCV valve.

In an idling state, the crankcase is ventilated through the PCV valve as described above. When the driver of the vehicle depresses an accelerator pedal, the open amount of the throttle valve increases. As a greater amount of air flows into the surge tank, the pressure of the surge tank changes from the negative pressure toward the atmospheric pressure. When the pressure of the surge tank becomes relatively close to the atmospheric pressure, the crankcase is not likely to be ventilated through the PCV valve.

In a case in which the internal combustion engine is a hydrogen engine, the need for ventilation of the crankcase is higher than in a case in which the internal combustion engine is a gasoline engine. The molecules of fuel used in a hydrogen engine are smaller than the molecules of fuel used in a gasoline engine. Accordingly, the molecules of fuel used in a hydrogen engine have a greater tendency to flow out of the combustion chamber into the crankcase through a gap between a piston and a cylinder. As a result, in a hydrogen engine, unburned fuel is more likely to collect in the crankcase than in a gasoline engine.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a ventilation system including a hydrogen engine and a vehicle controller is provided. The hydrogen engine includes an intake passage, a compressor of a forced-induction device arranged in the intake passage, a blow-by gas passage extending from a crankcase to a part of the intake passage located downstream of the compressor, a first positive crankcase ventilation (PCV) valve arranged in the blow-by gas passage, and a circulation passage extending from a part of the intake passage located upstream of the compressor to the crankcase. The first PCV valve is configured to open when a pressure of the intake passage at a downstream side of the compressor becomes lower than or equal to a first specified pressure that is lower than an atmospheric pressure. The vehicle controller includes processing circuitry. The processing circuitry is configured to execute a threshold value determination process that determines whether the pressure of the intake passage at the downstream side of the compressor is higher than or equal to a first threshold value that is lower than the atmospheric pressure. When a condition that the pressure of the intake passage at the downstream side of the compressor is higher than or equal to the first threshold value is satisfied, the processing circuitry is configured to execute a ventilation process that drives the hydrogen engine so that the pressure of the intake passage at the downstream side of the compressor becomes lower than or equal to the first specified pressure.

Other features and aspects will be apparent from the following detailed description, the drawings, and the claims.

### BRIEF DESCRIPTION OF THE DRAWINGS

FIG. 1 is a diagram of a vehicle including a ventilation system in accordance with a first embodiment.

FIG. 2 is a diagram illustrating a state in which a first PCV valve is open in a hydrogen engine included in the ventilation system shown in FIG. 1.

FIG. 3 is a diagram illustrating a state in which a second PCV valve is open in the hydrogen engine included in the ventilation system shown in FIG. 1.

FIG. 4 is a flowchart illustrating a process executed by a vehicle controller included in the ventilation system shown in FIG. 1.

FIG. 5 is a flowchart illustrating a ventilation process shown in FIG. 4.

FIG. 6 is a chart illustrating an operation of the ventilation system shown in FIG. 1, in which section (a) indicates an accelerator pedal input, section (b) indicates a ventilation flag, section (c) indicates an intake manifold pressure, section (d) indicates a shaft torque, section (e) indicates an MG assist torque, and section (f) indicates a state of charge (SOC).

FIG. 7 is a flowchart illustrating a process executed by a vehicle controller included in a ventilation system in accordance with a second embodiment.

FIG. 8 is a flowchart illustrating the process executed by the vehicle controller included in the ventilation system in accordance with the second embodiment.

FIG. 9 is a flowchart illustrating a second ventilation process shown in FIG. 8.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

A ventilation system in accordance with a first embodiment will now be described with reference to the drawings.

### Structure of Vehicle 100

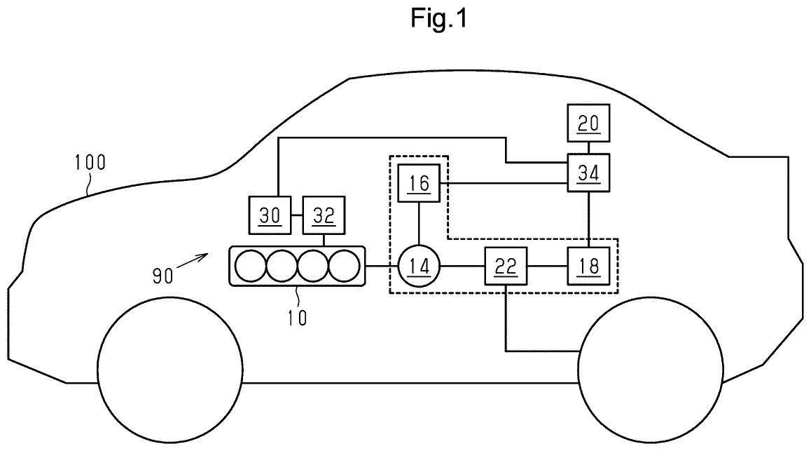

The structure of a vehicle 100 will be described with reference to FIG. 1. The vehicle 100 includes a hydrogen engine 10. The hydrogen engine 10 is an internal combustion engine that uses hydrogen as fuel. The vehicle 100 includes a first motor-generator 16 and a second motor-generator 18. Each of the first motor-generator 16 and the second motor-generator 18 is operable as a drive source of the vehicle 100. Each of the first motor-generator 16 and the second motor-generator 18 is also operable as a generator configured to generate electric energy using a driving force received from the hydrogen engine 10. The hydrogen engine 10, the first motor-generator 16, the second motor-generator 18, and a vehicle controller 30 form a ventilation system 90. The vehicle controller 30 will be described later.

The vehicle 100 further includes a power split mechanism 14. The power split mechanism 14 is a planetary gear mechanism having three rotary elements; namely, a sun gear, a planetary carrier, and a ring gear. The power split mechanism 14 is coupled to the hydrogen engine 10 and the first motor-generator 16. The power split mechanism 14 is connected to the second motor-generator 18 through a speed reducer 22. The speed reducer 22 is connected to drive wheels through a differential mechanism. The power split mechanism 14, the first motor-generator 16, the second motor-generator 18, and the speed reducer 22 form a transmission.

The first motor-generator 16 and the second motor-generator 18 are electrically connected to a battery 20 via a power control unit 34 (hereinafter, referred to as “PCU 34”). The PCU 34 is configured to regulate an amount of the electric power supplied from the battery 20 to the first motor-generator 16 and the second motor-generator 18, and an amount of the electric energy charged by the first motor-generator 16 and the second motor-generator 18 and stored in the battery 20.

The vehicle 100 includes an engine controller 32 that is an electronic controller configured to control the hydrogen engine 10. The vehicle 100 also includes the vehicle controller 30 configured to control the engine controller 32 and the PCU 34 in a centralized manner. Each of the vehicle controller 30 and the engine controller 32 is configured to be a computer unit including a storage device that stores programs and data for control, a central processing unit (CPU) that executes the programs stored in the storage device, and random-access memory (RAM) that serves as a working area when the CPU executes the programs. The storage device includes, for example, read-only memory (ROM).

The engine controller 32 receives detection signals indicating, for example, an amount of an accelerator pedal depressed by a driver, a speed of the vehicle 100, and the like. Then, the vehicle controller 30 uses the accelerator depression amount and the vehicle speed to calculate a required vehicle power, which is a required value of a driving force of the vehicle 100. Further, the vehicle controller 30 uses the required vehicle power, an amount of the electric energy stored in the battery 20, and the like to calculate a required engine output, a required MG1 torque, and a required MG2 torque. The required engine output is a required value of an engine output. The required MG1 torque is a required value of a driving/regeneration torque of the first motor-generator 16. The required MG2 torque is a required value of a driving/regeneration torque of the second motor-generator 18. Subsequently, the engine controller 32 controls an output of the hydrogen engine 10 in accordance with the required engine output, and the PCU 34 controls the torque of the first motor-generator 16 and the torque of the second motor-generator 18 in accordance with the required MG1 torque and the required MG2 torque. In this manner, traveling of the vehicle 100 is controlled.

### Structure of Hydrogen Engine 10

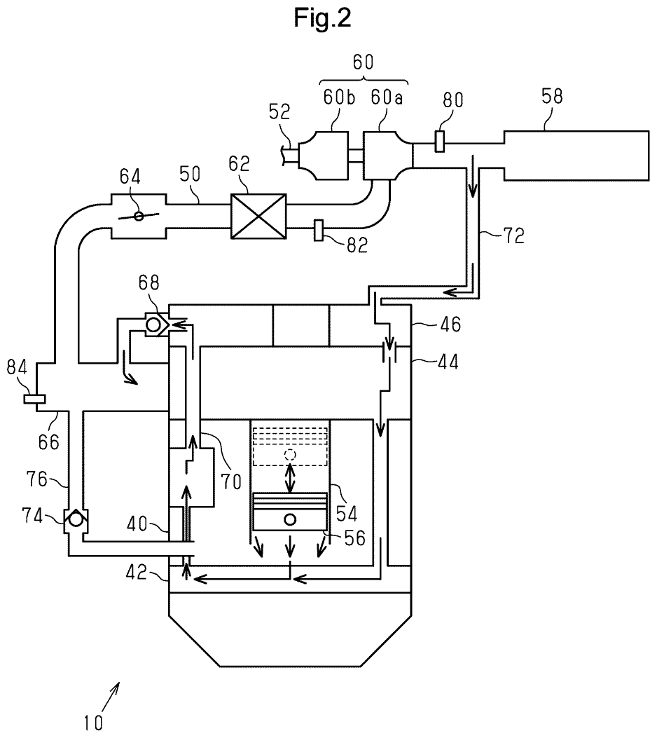

The structure of the hydrogen engine 10 will now be described with reference to FIG. 2.

The hydrogen engine 10 includes a cylinder block 40, a crankcase 42 connected to a lower part of the cylinder block 40, and a cylinder head 44 is connected to an upper part of the cylinder block 40. A ventilation case 46 is arranged on the cylinder head 44.

The cylinder block 40 includes a cylinder 54. A piston 56 is configured to reciprocate inside the cylinder 54. The cylinder 54 is connected to an intake passage 50 and an exhaust passage 52. An air cleaner 58, a compressor 60a of a forced-induction device 60, an intercooler 62, a throttle valve 64, and an intake manifold 66 are arranged in this order in the intake passage 50 from an upstream side. The throttle valve 64 is arranged on a part of the intake passage 50 located downstream of the compressor 60a. A turbine wheel 60b of the forced-induction device 60 is arranged in the exhaust passage 52.

A blow-by gas passage 70 extends from the crankcase 42 to the intake manifold 66. That is, the blow-by gas passage 70 extends from the crankcase 42 to a part of the intake passage 50 located downstream of the throttle valve 64. The blow-by gas passage 70 extends through the cylinder block 40, the cylinder head 44, and the ventilation case 46. A first positive crankcase ventilation (PCV) valve 68 is arranged at a part of the blow-by gas passage 70 located between the intake manifold 66 and the ventilation case 46. The first PCV valve 68 is configured to regulate an amount of the low-by gas flowing through the blow-by gas passage 70. The first PCV valve 68 is configured to open when a pressure of the intake passage 50 at a downstream side of the compressor 60a, more specifically, a pressure of the intake passage 50 at a downstream side of the throttle valve 64, becomes lower than or equal to a first specified pressure that is lower than the atmospheric pressure. As described later, this delivers the blow-by gas collecting in the crankcase 42 to the intake passage 50.

A circulation passage 72 extends from a part of the intake passage 50 located upstream of the compressor 60a to the crankcase 42. More specifically, the circulation passage 72 extends from a portion of the intake passage 50 located between the air cleaner 58 and the compressor 60a to the ventilation case 46. Further, the circulation passage 72 extends through the ventilation case 46, the cylinder head 44, and the cylinder block 40, and is open to the crankcase 42.

The hydrogen engine 10 further includes an air introducing conduit 76 extending from a part of the intake passage 50 located downstream of the throttle valve 64 to the crankcase 42. The hydrogen engine 10 further includes a second PCV valve 74 arranged in the air introducing conduit 76. The second PCV is configured to open when the pressure of the intake passage 50 at the downstream side of the compressor 60a, more specifically, the pressure of the intake passage 50 at the downstream side of the throttle valve 64, becomes higher than or equal to a second specified pressure that is higher than the atmospheric pressure.

A compressor inlet sensor 80 is arranged on a portion of the intake passage 50 located between the air cleaner 58 and the compressor 60a. The compressor inlet sensor 80 is configured to detect a pressure of the portion of the intake passage 50 located between the air cleaner 58 and the compressor 60a. The pressure detected by the compressor inlet sensor 80 is input to the vehicle controller 30.

A boost pressure sensor 82 is arranged on a portion of the intake passage 50 located between the compressor 60a and the intercooler 62. The boost pressure sensor 82 is configured to detect a pressure of the portion of the intake passage 50 located between the compressor 60a and the intercooler 62. The pressure detected by the boost pressure sensor 82 is input to the vehicle controller 30.

An intake manifold pressure sensor 84 is arranged on the intake manifold 66 in the intake passage 50. The intake manifold pressure sensor 84 is configured to detect a pressure of the intake manifold 66. The pressure detected by the intake manifold pressure sensor 84 is input to the vehicle controller 30.

### Air Flow

FIG. 2 illustrates a state in which the pressure of the intake passage 50 at the downstream side of the throttle valve 64 is lower than or equal to the first specified pressure, which is lower than the atmospheric pressure. In this state, the first PCV valve 68 is open, and the second PCV valve 74 is closed. The arrows shown in FIG. 2 indicate the flow of air.

When the first PCV valve 68 is open, the blow-by gas, which leaked from a combustion chamber into the crankcase 42, flows from the crankcase 42 through the blow-by gas passage 70 to the intake passage 50, and fresh air flows through the circulation passage 72 into the crankcase 42. This delivers the blow-by gas collecting in the crankcase 42 to the intake passage 50.

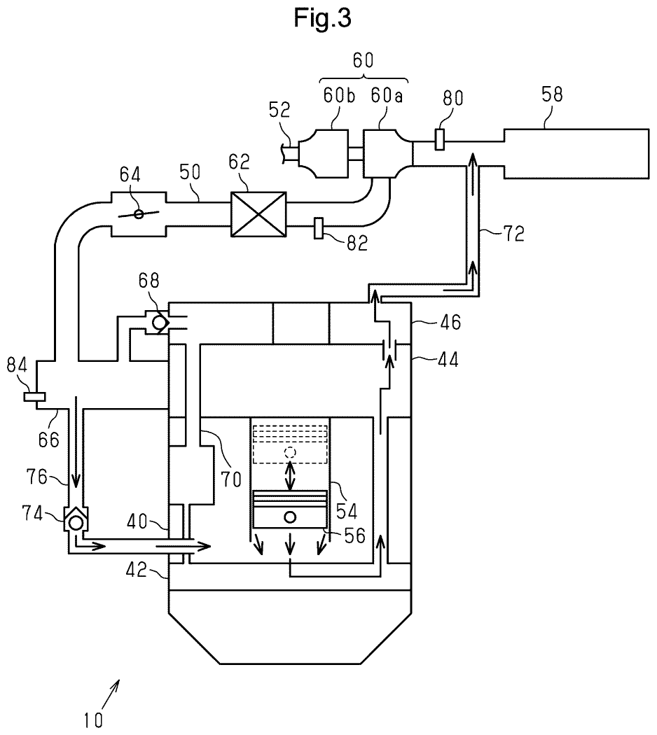

FIG. 3 illustrates a state in which the pressure of the intake passage 50 at the downstream side of the throttle valve 64 is higher than or equal to the second specified pressure, which is higher than the atmospheric pressure. In this case, the first PCV valve 68 is closed, and the second PCV valve 74 is open. The arrows shown in FIG. 3 indicate the flow of air.

When the second PCV valve 74 is open, the blow-by gas flows from the crankcase 42 through the circulation passage 72 into the intake passage 50, and fresh air flows through the air introducing conduit 76 into the crankcase 42.

### Processing Performed by Vehicle Controller 30

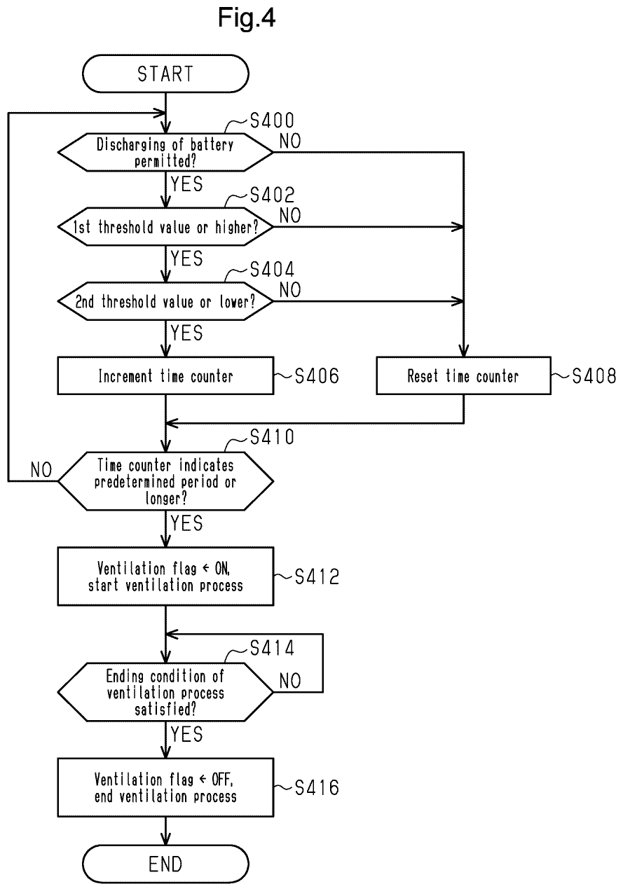

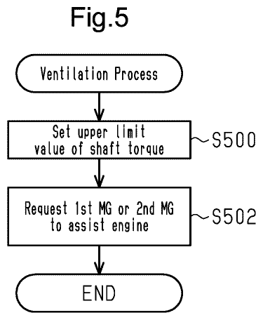

A process executed by the vehicle controller 30 will now be described with reference to FIGS. 4 and 5. The vehicle controller 30 starts the process shown in FIG. 4 when the vehicle 100 is activated. When the vehicle 100 is activated, a ventilation flag, which will be described later, is OFF.

In step S400, the vehicle controller 30 executes a discharge determination process that determines whether discharging of the battery 20 connected to the first motor-generator 16 and the second motor-generator 18 is permitted. Specifically, the vehicle controller 30 determines whether a state of charge (SOC) of the battery 20 is higher than or equal to a discharge threshold value. The vehicle controller 30 determines that discharging of the battery 20 is permitted when the SOC is higher than or equal to the discharge threshold value. When an affirmative determination is given in step S400 (S400: YES), the vehicle controller 30 proceeds to step S402. When a negative determination is given in step S400 (S400: NO), the vehicle controller 30 proceeds to step S408. In step S408, the vehicle controller 30 resets a time counter, which will be described later, to zero.

In step S402, the vehicle controller 30 executes a threshold value determination process that determines whether the pressure of the intake passage 50 at the downstream side of the throttle valve 64 is higher than or equal to a first threshold value that is lower than the atmospheric pressure. The first threshold value is lower than or equal to the first specified pressure. When an affirmative determination is given in step S402 (S402: YES), the vehicle controller 30 proceeds to step S404. When a negative determination is given in step S402 (S402: NO), the vehicle controller 30 proceeds to step S408.

In step S404, the vehicle controller 30 executes a threshold value determination process that determines whether the pressure of the intake passage 50 at the downstream side of the throttle valve 64 is lower than or equal to a second threshold value that is higher than the atmospheric pressure. The second threshold value is higher than or equal to the second specified pressure. The second threshold value is greater than the first threshold value. When an affirmative determination is given in step S404 (S404: YES), the vehicle controller 30 proceeds to step S406. When a negative determination is given in step S404 (S404: NO), the vehicle controller 30 proceeds to step S408. Accordingly, “second threshold value≥second specified pressure>atmospheric pressure>first specified pressure≥first threshold value” is satisfied. Based on steps S402 and S404, the vehicle controller 30 determines whether the pressure of the intake passage 50 at the downstream side of the throttle valve 64 is relatively close to the atmospheric pressure. When the pressure of the intake passage 50 at the downstream side of the throttle valve 64 is relatively close to the atmospheric pressure, both the first PCV valve 68 and the second PCV valve 74 are closed. This means that the crankcase 42 is not being ventilated.

In step S406, the vehicle controller 30 increments the time counter. At the beginning of the process shown in FIG. 4, the time counter indicates zero. At the end of the process shown in FIG. 4, the time counter is reset to zero. The time counter measures a length of time over which affirmative determinations are continuously given in all of steps S400, S402, and S404.

After step S406 or S408, the vehicle controller 30 proceeds to step S410. In step S410, the vehicle controller 30 determines whether the time counter indicates a predetermined period or longer. The predetermined period is determined in advance taking into consideration a time length in which a certain amount of blow-by gas collects in the crankcase 42. The predetermined period is, for example, ten seconds. When an affirmative determination is given in step S410 (S410: YES), the vehicle controller 30 proceeds to step S412. When a negative determination is given in step S410 (S410: NO), the vehicle controller 30 returns to step S400.

In step S412, the vehicle controller 30 shifts the ventilation flag to ON. The ventilation flag being ON means that the vehicle controller 30 should execute a ventilation process, which will be described below. The vehicle controller 30 starts the ventilation process in step S412. Based on steps S400 to S412, the vehicle controller 30 executes the ventilation process when a logical conjunction remains satisfied for the predetermined period. The logical conjunction includes a condition that discharging of the battery 20 is permitted and a condition that the pressure of the intake passage 50 at the downstream side of the throttle valve 64 is higher than or equal to the first threshold value and lower than or equal to the second threshold value. The second threshold value is higher than the atmospheric pressure and the first threshold value.

The ventilation process will now be described with reference to FIG. 5. The ventilation process includes driving the hydrogen engine 10 so that the pressure of the intake passage 50 at the downstream side of the throttle valve 64 becomes lower than or equal to the first specified pressure. The ventilation process further includes assisting in the output of the hydrogen engine 10 with the first motor-generator 16 or the second motor-generator 18 by discharging the battery 20. In step S500, the vehicle controller 30 sets an upper limit value of the shaft torque output from the hydrogen engine 10. This limits the open degree of the throttle valve 64, thereby avoiding the shaft torque output from the hydrogen engine 10 from exceeding the upper limit value. Based on step S500, the vehicle controller 30 drives the hydrogen engine 10 by setting the upper limit value of the shaft torque, so that the pressure of the intake passage 50 at the downstream side of the throttle valve 64 becomes lower than or equal to the first specified pressure. Next, in step S502, the vehicle controller 30 requests the first motor-generator 16 or the second motor-generator 18 to assist in the output of the hydrogen engine 10 by discharging the battery 20, so as to obtain the required power. Then, the vehicle controller 30 ends the process shown in FIG. 5.

As shown in FIG. 4, after step S412, the vehicle controller 30 proceeds to step S414. In step S414, the vehicle controller 30 determines whether an ending condition of the ventilation process is satisfied. The ending condition of the ventilation process includes that discharging of the battery 20 is no longer permitted. Specifically, discharging of the battery 20 is no longer permitted when the SOC becomes lower than the above-described discharge threshold value. The end condition of the ventilation process further includes that supercharging of the hydrogen engine 10 is requested. When a negative determination is given in step S414 (S414: NO), the vehicle controller 30 repeats step S414. When an affirmative determination is given in step S414 (S414: YES), the vehicle controller 30 proceeds to step S416.

In step S416, the vehicle controller 30 shifts the ventilation flag to OFF. The vehicle controller 30 ends the ventilation process in step S416. Specifically, the vehicle controller 30 cancels the setting of the upper limit value of the shaft torque. Further, the vehicle controller 30 cancels the above-described request for assist in the output of the hydrogen engine 10.

Based on steps S414 and S416, the vehicle controller 30 ends the ventilation process when the ending condition of the ventilation process is satisfied. The ending condition of the ventilation process includes that discharging of the battery 20 is no longer permitted.

After step S416, the vehicle controller 30 ends the process shown in FIG. 4.

### Operation of the First Embodiment

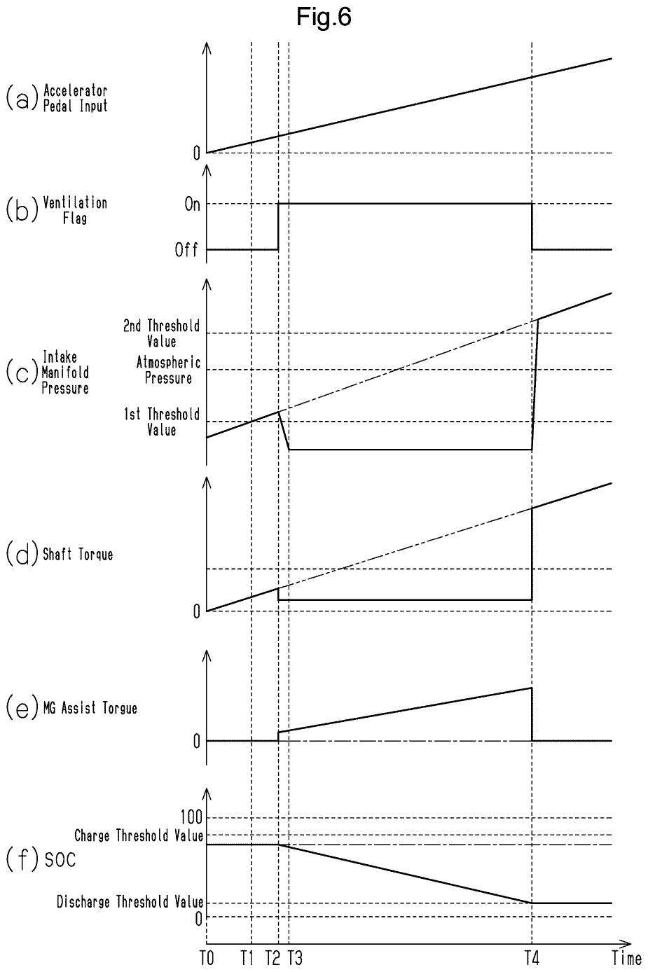

The operation of the first embodiment will now be described with reference to FIG. 6. The solid lines shown in FIG. 6 represent the operation of the first embodiment. The single-dashed lines shown in FIG. 6 indicate a comparative example in which the process of the first embodiment is not executed. In the example shown in FIG. 6, from time T0 to time T4, the SOC remains higher than or equal to the discharge threshold value. Accordingly, when the vehicle controller 30 performs step S400 of FIG. 4 between time T0 and time T4, the vehicle controller 30 gives an affirmative determination in step S400 (S400: YES).

At time T0, the hydrogen engine 10 is in an idling state. That is, the accelerator pedal input is zero. When the hydrogen engine 10 is in an idling state, descending of the piston 56 causes the pressure of the intake passage 50 at the downstream side of the throttle valve 64 to become negative, approximately 60 kPa.

From time T0, the accelerator pedal input is increased. This means that the open amount of the throttle valve 64 is increased as the accelerator pedal input increases, such that the pressure of the intake passage 50 at the downstream side of the throttle valve 64 becomes higher.

At time T1, the intake manifold pressure, which indicates the pressure of the intake passage 50 at the downstream side of the throttle valve 64, exceeds the first threshold value. As shown in section (c) of FIG. 6, from time T1 to time T2, the intake manifold pressure remains higher than or equal to the first threshold value and lower than or equal to the second threshold value. Therefore, the vehicle controller 30 gives an affirmative determination in steps S402 and S404 between time T1 and time T2 (S402: YES, S404: YES).

At time T2, the time counter reaches the predetermined period (S410: YES). Accordingly, as shown in section (b) of FIG. 6, at time T2, the vehicle controller 30 shifts the ventilation flag from OFF to ON. The vehicle controller 30 starts the ventilation process at time T2. As shown in sections (d) and (e) of FIG. 6, at time T2, the shaft torque is decreased and an MG assist torque is increased. The MG assist torque is the torque of the first motor-generator 16 and/or the torque of the second motor-generator 18 that assists the output of the hydrogen engine 10.

As shown in section (c) of FIG. 6, at time T3, the intake manifold pressure reaches a value smaller than the first threshold value.

As shown in section (a) of FIG. 6, from time T2 to time T4, the accelerator pedal input increases. As shown in section (d) of FIG. 6, from time T2 to time T4, the shaft torque is constant. Thus, as shown in section (e) of FIG. 6, the MG assist torque is increased as the accelerator pedal input increases.

At time T4, the SOC reaches the discharge threshold value. This satisfies the ending condition of the ventilation process (S414: YES). Therefore, the ventilation flag is shifted to OFF at time T4 (S416). That is, the vehicle controller 30 ends the ventilation process at time T4.

In the comparative example, the intake manifold pressure remains in a range of the first threshold value to the second threshold value for a longer period of time than in the first embodiment. In this regard, the first embodiment shortens the period in which the intake manifold pressure remains in the range of the first threshold value to the second threshold value. The first PCV valve 68 opens when the pressure of the intake passage 50 at the downstream side of the throttle valve 64 becomes lower than or equal to the first specified pressure. The first threshold value is lower than or equal to the first specified pressure. Thus, the first embodiment allows the crankcase 42 to be efficiently ventilated through the first PCV valve 68.

### Advantages of the First Embodiment

(1) The ventilation system 90 includes the hydrogen engine 10, the first motor-generator 16, the second motor-generator 18, and the vehicle controller 30. The first motor-generator 16 and the second motor-generator 18 are each operable as a drive source of the vehicle 100. The hydrogen engine 10 includes the intake passage 50, the compressor 60a of the forced-induction device 60 arranged in the intake passage 50, and the throttle valve 64. The throttle valve 64 is arranged on a part of the intake passage 50 located downstream of the compressor 60a. The hydrogen engine 10 further includes the blow-by gas passage 70 that extends from the crankcase 42 to a part of the intake passage 50 located downstream of the throttle valve 64. The hydrogen engine 10 further includes the first PCV valve 68 arranged in the blow-by gas passage 70. The first PCV valve 68 is configured to open when the pressure of the intake passage 50 at the downstream side of the throttle valve 64 becomes lower than or equal to the first specified pressure, which is lower than the atmospheric pressure. The hydrogen engine 10 further includes the air introducing conduit 76 that extends from a part of the intake passage 50 located downstream of the throttle valve 64 to the crankcase 42. The hydrogen engine 10 further includes the second PCV valve 74 arranged in the air introducing conduit 76. The second PCV valve 74 is configured to open when the pressure of the intake passage 50 at the downstream side of the throttle valve 64 becomes higher than or equal to the second specified pressure, which is higher than the atmospheric pressure. The hydrogen engine 10 further includes the circulation passage 72 that extends from a part of the intake passage 50 located upstream of the compressor 60a to the crankcase 42. The vehicle controller 30 is configured to execute the discharge determination process that determines whether discharging of the battery 20 connected to the first motor-generator 16 and the second motor-generator 18 is permitted. The vehicle controller 30 is configured to execute the threshold value determination process that determines whether the pressure of the intake passage 50 at the downstream side of the throttle valve 64 is higher than or equal to the first threshold value, which is lower than the atmospheric pressure, and lower than or equal to the second threshold value, which is higher than the atmospheric pressure. When the logical conjunction including a condition that discharging of the battery 20 is permitted and a condition that the pressure of the intake passage 50 at the downstream side of the throttle valve 64 is higher than or equal to the first threshold value and lower than or equal to the second threshold value remains satisfied for the predetermined period, the vehicle controller 30 is configured to execute the ventilation process. The ventilation process includes driving the hydrogen engine 10 so that the pressure of the intake passage 50 at the downstream side of the throttle valve 64 becomes lower than or equal to the first specified pressure. The ventilation process further includes assisting in the output of the hydrogen engine 10 with the first motor-generator 16 or the second motor-generator 18 by discharging the battery 20.

When the pressure of the intake passage 50 at the downstream side of the throttle valve 64 changes from the negative pressure and becomes relatively close to the atmospheric pressure, the crankcase 42 is not likely to be ventilated through the first PCV valve 68. In such a case, if discharging of the battery 20 is permitted, the vehicle controller 30 drives the hydrogen engine 10 so as to ventilate the crankcase 42 through the first PCV valve 68. This avoids a situation in which the crankcase 42 is not readily ventilated as the pressure of the intake passage 50 at the downstream side of the throttle valve 64 changes from the negative pressure toward the atmospheric pressure. Furthermore, the first motor-generator 16 or the second motor-generator 18 compensates for the reduction in the shaft torque resulting from driving the hydrogen engine 10 as described above. Therefore, such a reduction in the shaft torque will not cause discomfort to the driver.

(2) The logical conjunction includes a condition that discharging of the battery 20 is permitted and a condition that the pressure of the intake passage 50 at the downstream side of the throttle valve 64 is higher than or equal to the first threshold value and lower than or equal to the second threshold value. The second threshold value is higher than the atmospheric pressure and the first threshold value.

When the pressure of the intake passage 50 at the downstream side of the throttle valve 64 is exceptionally high, the ventilation process will not be executed. When the pressure of the intake passage 50 at the downstream side of the throttle valve 64 is exceptionally high, it is highly likely that the crankcase 42 is already being ventilated through the second PCV valve 74. Accordingly, the above configuration avoids unnecessary ventilation processing.

(3) The vehicle controller 30 drives the hydrogen engine 10 by setting the upper limit value of the shaft torque output from the hydrogen engine 10, so that the pressure of the intake passage 50 at the downstream side of the throttle valve 64 becomes lower than or equal to the first specified pressure.

With this configuration, the hydrogen engine 10 is driven to ventilate the crankcase 42 through the first PCV valve 68 when the upper limit value of the shaft torque is set.

(4) The vehicle controller 30 is configured to end the ventilation process when the ending condition of the ventilation process is satisfied. The ending condition of the ventilation process includes that discharging of the battery 20 is no longer permitted.

With this configuration, the battery 20 will not be discharged when discharging of the battery 20 is not permitted.

(5) The vehicle controller 30 is configured to end the ventilation process when the ending condition of the ventilation process is satisfied. The ending condition of the ventilation process includes that supercharging of the hydrogen engine 10 is requested.

When supercharging of the hydrogen engine 10 is requested, it is highly likely that the pressure of the intake passage 50 at the downstream side of the throttle valve 64 becomes higher than or equal to the second specified pressure such that the crankcase 42 is ventilated through the second PCV valve 74. Accordingly, in such a case, the above configuration avoids unnecessary ventilation processing by ending the ventilation process.

### Second Embodiment

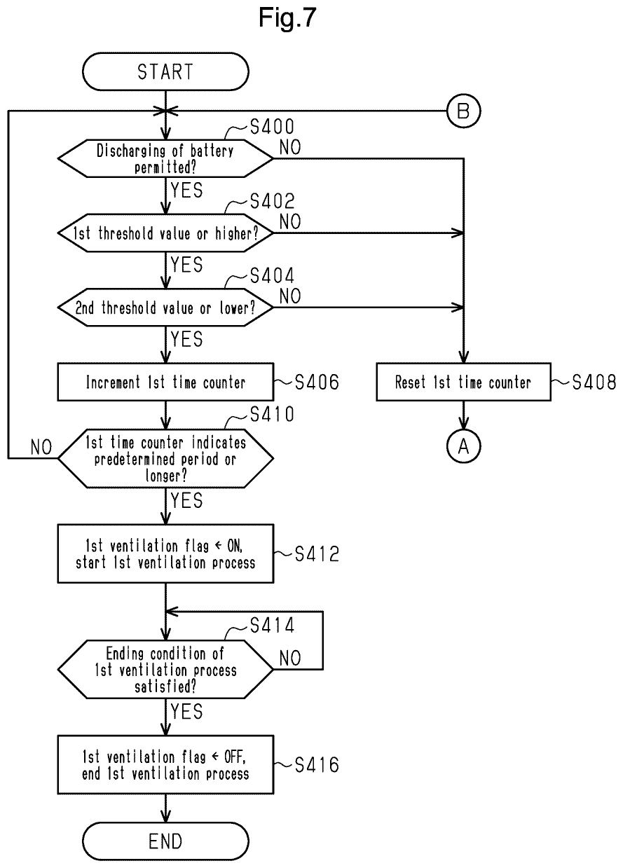

A ventilation system in accordance with a second embodiment will now be described with reference to FIGS. 7 to 9. The elements of the ventilation system in accordance with the second embodiment that are the same as those of the ventilation system in accordance with the first embodiment will not be described in detail.

In the second embodiment, the vehicle controller 30 performs steps S400 to S416 in the same manner as in the first embodiment. The threshold value determination process of the first embodiment corresponds to a first threshold value determination process of the second embodiment. The time counter of the first embodiment corresponds to a first time counter of the second embodiment. The ventilation process of the first embodiment corresponds to a first ventilation process of the second embodiment. The ventilation flag of the first embodiment corresponds to a first ventilation flag of the second embodiment. In the first embodiment, the vehicle controller 30 proceeds to step S410 after step S408. In contrast, in the second embodiment, the vehicle controller 30 proceeds to step S800 after step S408.

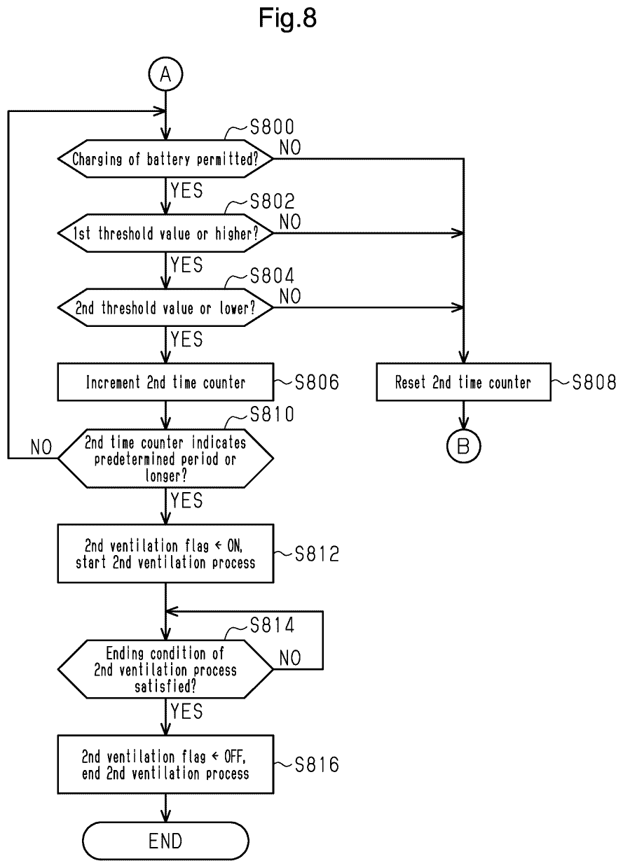

As shown in FIG. 8, in step S800, the vehicle controller 30 executes a charge determination process that determines whether charging of the battery 20 connected to the first motor-generator 16 and the second motor-generator 18 is permitted. Specifically, the vehicle controller 30 determines whether the SOC of the battery 20 is lower than or equal to a charge threshold value. The charge threshold value is greater than the above-described discharge threshold value. The vehicle controller 30 determines that charging of the battery 20 is permitted when the SOC is lower than or equal to the charge threshold value. When an affirmative determination is given in step S800 (S800: YES), the vehicle controller 30 proceeds to step S802. When a negative determination is given in step S800 (S800: NO), the vehicle controller 30 proceeds to step S808. In step S808, the vehicle controller 30 resets a second time counter, which will be described later, to zero. After step S808, the vehicle controller 30 returns to step S400 of FIG. 7.

In step S802, the vehicle controller 30 executes a second threshold value determination process that determines whether the pressure of the intake passage 50 at the downstream side of the throttle valve 64 is higher than or equal to the first threshold value, which is lower than the atmospheric pressure. When an affirmative determination is given in step S802 (S802: YES), the vehicle controller 30 proceeds to step S804. When a negative determination is given in step S802 (S802: NO), the vehicle controller 30 proceeds to step S808.

In step S804, the vehicle controller 30 executes a second threshold value determination process that determines whether the pressure of the intake passage 50 at the downstream side of the throttle valve 64 is lower than or equal to the second threshold value that is higher than the atmospheric pressure. The second threshold value is higher than or equal to the second specified pressure. The second threshold value is greater than the first threshold value. When an affirmative determination is given in step S804 (S804: YES), the vehicle controller 30 proceeds to step S806. When a negative determination is given in step S804 (S804: NO), the vehicle controller 30 proceeds to step S808.

In step S806, the vehicle controller 30 increments the second time counter. At the beginning of the process shown in FIG. 8, the second time counter indicates zero. At the end of the process shown in FIG. 8, the second time counter is reset to zero. The second time counter measures a length of time over which affirmative determinations are continuously given in all of steps S800, S802, and S804.

After step S806, the vehicle controller 30 proceeds to step S810. In step S810, the vehicle controller 30 determines whether the second time counter indicates a predetermined period or longer. When an affirmative determination is given in step S810 (S810: YES), the vehicle controller 30 proceeds to step S812. When a negative determination is given in step S810 (S810: NO), the vehicle controller 30 returns to step S800.

In step S812, the vehicle controller 30 shifts the second ventilation flag to ON. The second ventilation flag being ON means that the vehicle controller 30 should execute a second ventilation process, which will be described below. In step S812, the vehicle controller 30 starts the second ventilation process. Based on steps S800 to S812, the vehicle controller 30 executes the second ventilation process when a logical conjunction remains satisfied for the predetermined period. The logical conjunction includes a condition that charging of the battery 20 is permitted and a condition that the pressure of the intake passage 50 at the downstream side of the throttle valve 64 is higher than or equal to the first threshold value and lower than or equal to the second threshold value. The second threshold value is higher than the atmospheric pressure and the first threshold value.

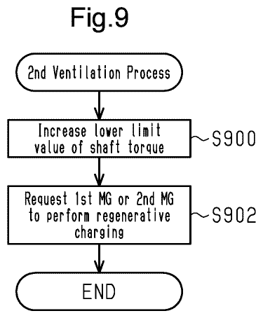

The second ventilation process will now be described with reference to FIG. 9. The second ventilation process is a process that supercharges the hydrogen engine 10 so that the pressure of the intake passage 50 at the downstream side of the throttle valve 64 becomes higher than or equal to the second specified pressure. The second ventilation process also performs regenerative charging of the battery 20. The vehicle controller 30 increases a lower limit value of a shaft torque output from the hydrogen engine 10. Based on step S900, the vehicle controller 30 supercharges the hydrogen engine 10 by increasing the lower limit value of the shaft torque output from the hydrogen engine 10. In step S902, the vehicle controller 30 requests the first motor-generator 16 or the second motor-generator 18 to perform regenerative charging. Then, the vehicle controller 30 ends the process shown in FIG. 9.

As shown in FIG. 8, after step S812, the vehicle controller 30 proceeds to step S814. In step S814, the vehicle controller 30 determines whether an ending condition of the second ventilation process is satisfied. The ending condition of the second ventilation process includes that charging of the battery 20 is no longer permitted. Specifically, charging of the battery 20 is no longer permitted when the SOC becomes higher than the above-described charge threshold value. When a negative determination is given in step S814 (S814: NO), the vehicle controller 30 repeats step S814. When an affirmative determination is given in step S814 (S814: YES), the vehicle controller 30 proceeds to step S816.

In step S816, the vehicle controller 30 shifts the second ventilation flag to OFF. The vehicle controller 30 ends the second ventilation process in step S816. Specifically, the vehicle controller 30 cancels the setting of the lower limit value of the shaft torque. Further, the vehicle controller 30 cancels the above-described request for regenerative charging.

After step S816, the vehicle controller 30 ends the process shown in FIG. 8.

### Operation of the Second Embodiment

When the pressure of the intake passage 50 at the downstream side of the throttle valve 64 is relatively close to the atmospheric pressure, both the first PCV valve 68 and the second PCV valve 74 are closed. This means that the crankcase 42 is not being ventilated.

The vehicle controller 30 executes the first ventilation process when the pressure of the intake passage 50 at the downstream side of the throttle valve 64 remains relatively close to the atmospheric pressure and discharging of the battery 20 is permitted (step S410 in FIG. 7: YES, step S412).

When discharging of the battery 20 is not permitted, the vehicle controller 30 proceeds to the process shown in FIG. 8 (step S400 in FIG. 7: NO). The vehicle controller 30 executes the second ventilation process when the pressure of the intake passage 50 at the downstream side of the throttle valve 64 remains relatively close to the atmospheric pressure and charging of the battery 20 is permitted (step S810 in FIG. 8: YES, step S812).

### Advantages of the Second Embodiment

(2-1) The ventilation process of the first embodiment corresponds to the first ventilation process of the second embodiment. The threshold value determination process of the first embodiment corresponds to the first threshold value determination process of the second embodiment. When discharging of the battery 20 is not permitted, the vehicle controller 30 performs the following processing. The vehicle controller 30 executes the charge determination process that determines whether charging of the battery 20 is permitted. The vehicle controller 30 executes the second threshold value determination process that determines whether the pressure of the intake passage 50 at the downstream side of the throttle valve 64 is higher than or equal to the first threshold value, which is lower than the atmospheric pressure, and lower than or equal to the second threshold value, which is higher than the atmospheric pressure. When the logical conjunction including a condition that charging of the battery 20 is permitted and a condition that the pressure of the intake passage 50 at the downstream side of the throttle valve 64 is higher than or equal to the first threshold value and lower than or equal to the second threshold value remains satisfied for the predetermined period, the vehicle controller 30 executes the second ventilation process. The second ventilation process supercharges the hydrogen engine 10 so that the pressure of the intake passage 50 at the downstream side of the throttle valve 64 becomes higher than or equal to the second specified pressure. The second ventilation process also performs regenerative charging of the battery 20.

Even when discharging of the battery 20 is not permitted, the second ventilation process may be performed if charging of the battery 20 is permitted. This facilitates ventilation of the crankcase 42.

### MODIFIED EXAMPLES

The first and second embodiments may be modified as described below. The modified examples described below may be combined as long as there is no technical contradiction.

The structure of the vehicle 100 may be changed. For example, the vehicle 100 may include only one motor-generator. In such a case, the ventilation system 90 includes the hydrogen engine 10, the single motor-generator, and the vehicle controller 30.

In the first embodiment, the first motor-generator 16 and the second motor-generator 18 are mechanically indirectly connected to the hydrogen engine 10. Instead, the vehicle 100 may include a motor-generator mechanically directly connected to the hydrogen engine 10.

In the first embodiment, the logical conjunction includes a condition that discharging of the battery 20 is permitted and a condition that the pressure of the intake passage 50 at the downstream side of the throttle valve 64 is higher than or equal to the first threshold value and lower than or equal to the second threshold value. For example, the logical conjunction may include a condition that discharging of the battery 20 is permitted and a condition that the pressure of the intake passage 50 at the downstream side of the throttle valve 64 is higher than or equal to the first threshold value.

In the first embodiment, the vehicle controller 30 executes the ventilation process when the logical conjunction remains satisfied for the predetermined period. Instead, the vehicle controller 30 may execute the ventilation process when the logical conjunction is satisfied. That is, the vehicle controller 30 may execute the ventilation process when the logical conjunction is momentarily satisfied.

The discharge determination process may be omitted.

The logical conjunction does not have to include the condition that discharging of the battery 20 is permitted.

The ventilation process does not have to include assisting in the output of the hydrogen engine 10 with the first motor-generator 16 or the second motor-generator 18 by discharging the battery 20.

In the first embodiment, the vehicle controller 30 drives the hydrogen engine 10 by setting the upper limit value of the shaft torque output from the hydrogen engine 10, so that the pressure of the intake passage 50 at the downstream side of the throttle valve 64 becomes lower than or equal to the first specified pressure. Instead, for example, the vehicle controller 30 may decrease the shaft torque output from the hydrogen engine 10 to a fixed value.

In the first embodiment, the vehicle controller 30 is configured to end the ventilation process when the ending condition of the ventilation process is satisfied, and the ending condition of the ventilation process includes that discharging of the battery 20 is no longer permitted. The ending condition of the ventilation process may include a condition that a specified period elapses from the beginning of the ventilation process.

In the first and second embodiments, the engine controller 32, the PCU 34, and the vehicle controller 30 each include a central processing unit (CPU), random-access memory (RAM), and read-only memory (ROM). The engine controller 32, the PCU 34, and the vehicle controller 30 each perform software processing. However, such a configuration is merely an example. For example, the engine controller 32, the PCU 34, and the vehicle controller 30 may each include a dedicated hardware circuit that performs at least part of the software processing described in the above embodiments. The dedicated hardware circuit is, for example, an application-specific integrated circuit (ASIC). That is, each of the engine controller 32, the PCU 34, and the vehicle controller 30 may only have any one of the following configurations (a) to (c). (a) The engine controller 32, the PCU 34, and the vehicle controller 30 each include a processor that executes all processes according to programs and a program storage device, such as ROM, that stores the programs. In other words, the engine controller 32, the PCU 34, and the vehicle controller 30 each include a software execution device. (b) The engine controller 32, the PCU 34, and the vehicle controller 30 each include a processor that executes some of processes according to programs and a program storage device. Further, the engine controller 32, the PCU 34, and the vehicle controller 30 each include a dedicated hardware circuit that executes the remaining processes. (c) The engine controller 32, the PCU 34, and the vehicle controller 30 each include a dedicated hardware circuit that executes all processes. There may be more than one software execution device and/or more than one dedicated hardware circuit. That is, the above-described processes may be executed by processing circuitry that includes at least one of a software execution device and a dedicated hardware circuit. The processing circuitry may include more than one software execution device and more than one dedicated hardware circuit. The program storage device, or computer readable medium, includes any available storage medium that is accessible by a versatile computer or a dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A ventilation system, comprising:
a hydrogen engine; and
a vehicle controller, wherein
the hydrogen engine includes:
an intake passage;
a compressor of a forced-induction device arranged in the intake passage;
a blow-by gas passage extending from a crankcase to a part of the intake passage located downstream of the compressor;
a first positive crankcase ventilation (PCV) valve arranged in the blow-by gas passage and configured to open when a pressure of the intake passage at a downstream side of the compressor becomes lower than or equal to a first specified pressure that is lower than an atmospheric pressure; and
a circulation passage extending from a part of the intake passage located upstream of the compressor to the crankcase,
the vehicle controller includes processing circuitry,
the processing circuitry is configured to execute a threshold value determination process that determines whether the pressure of the intake passage at the downstream side of the compressor is higher than or equal to a first threshold value that is lower than the atmospheric pressure, and
when a condition that the pressure of the intake passage at the downstream side of the compressor is higher than or equal to the first threshold value is satisfied, the processing circuitry is configured to execute a ventilation process that drives the hydrogen engine so that the pressure of the intake passage at the downstream side of the compressor becomes lower than or equal to the first specified pressure.

2. The ventilation system according to claim 1, wherein the processing circuitry is configured to execute the ventilation process when the condition that the pressure of the intake passage at the downstream side of the compressor is higher than or equal to the first threshold value remains satisfied for a predetermined period.

3. The ventilation system according to claim 1, wherein
under the condition, the pressure of the intake passage at the downstream side of the compressor is higher than or equal to the first threshold value and lower than or equal to a second threshold value, and
the second threshold value is higher than the atmospheric pressure and the first threshold value.

4. The ventilation system according to claim 1, further comprising a motor-generator operable as a drive source of a vehicle,
wherein, when discharging of a battery connected to the motor-generator is permitted during the ventilation process, the processing circuitry is configured to control the motor-generator so that the motor-generator assists in output of the hydrogen engine by discharging the battery during the ventilation process.

5. The ventilation system according to claim 1, wherein the hydrogen engine further includes:
an air introducing conduit extending from a part of the intake passage located downstream of the compressor to the crankcase; and
a second PCV valve arranged in the air introducing conduit and configured to open when the pressure of the intake passage at the downstream side of the compressor becomes higher than or equal to a second specified pressure that is higher than the atmospheric pressure.

6. The ventilation system according to claim 1, wherein the processing circuitry is configured to drive the hydrogen engine by setting an upper limit value of a shaft torque output from the hydrogen engine, so that the pressure of the intake passage at the downstream side of the compressor becomes lower than or equal to the first specified pressure.

7. The ventilation system according to claim 4, wherein
the processing circuitry is configured to end the ventilation process when an ending condition of the ventilation process is satisfied, and
the ending condition of the ventilation process includes that discharging of the battery is no longer permitted.

8. The ventilation system according to claim 1, wherein
the processing circuitry is configured to end the ventilation process when an ending condition of the ventilation process is satisfied, and
the ending condition of the ventilation process includes that supercharging of the hydrogen engine is requested.

9. The ventilation system according to claim 5, further comprising a motor-generator operable as a generator configured to generate electric energy using a driving force received from the hydrogen engine, the motor-generator being also operable as a drive source of a vehicle, wherein
the ventilation process is a first ventilation process,
the threshold value determination process is a first threshold value determination process, and
when discharging of a battery connected to the motor-generator is not permitted:
the processing circuitry is configured to execute a charge determination process that determines whether charging of the battery is permitted;
the processing circuitry is configured to execute a second threshold value determination process that determines whether the pressure of the intake passage at the downstream side of the compressor is higher than or equal to the first threshold value, which is lower than the atmospheric pressure, and lower than or equal to a second threshold value that is higher than the atmospheric pressure; and
when a logical conjunction including a condition that charging of the battery is permitted and a condition that the pressure of the intake passage at the downstream side of the compressor is higher than or equal to the first threshold value and lower than or equal to the second threshold value remains satisfied for a predetermined period, the processing circuitry is configured to execute a second ventilation process that supercharges the hydrogen engine so that the pressure of the intake passage at the downstream side of the compressor becomes higher than or equal to the second specified pressure, and causes the motor-generator to perform regenerative charging of the battery.
